(19) United States
(12) Patent Application Publication
(10) Pub. No.: US 2007/0218448 A1
(43) Pub. Date: Sep. 20, 2007

(54) METHODS AND SYSTEMS FOR EFFICIENT DEVELOPMENT OF INTERACTIVE MULTIMEDIA ELECTRONIC LEARNING CONTENT

(75) Inventors: Gregory W. Harmeyer, Liberty Township, OH (US); Kevin B. Norr, Wilmington, NC (US); Kevin C. Moore, Cittenden, KY (US)

Correspondence Address: DINSMORE & SHOHL, LLP, 1900 CHEMED CENTER, 255 EAST FIFTH STREET, CINCINNATI, OH, 45202, US

(73) Assignee: Tier One Performance Solutions LLC, Covington, KY (US)

(21) Appl. No.: 11/672,454

(22) Filed: Feb. 7, 2007

Related U.S. Application Data
(60) Provisional application No. 60/771,573, filed on Feb. 8, 2006.

(51) Int. Cl. G09B 3/00

(52) U.S. Cl. 434/350

(57) ABSTRACT

Methods and systems for rapid and efficient development of content-rich customized e-learning programs. In some embodiments, the subject matter expert is presented with a variety of predetermined page types for potential use in teaching a topic. Based upon the page type selected, a storyboard template is provided defining points of a multimedia presentation, the template having guidance for the subject matter expert to fill in information related to the page type. The information can comprise text indicating what is to be displayed, what is to be spoken in a voiceover, and/or what action is to take place on screen. Based upon the content filled into the storyboard by the expert, multimedia animation templates that mirror the storyboard are then filled in and generated for use in an electronic learning format. The templates can be flash movies and can include graphics, animation, voiceovers, videos, interactive mouseover effects, and other rich content.

### CROSS REFERENCE TO RELATED APPLICATION

This application claims the benefit of U.S. Provisional Application No. 60/771,573, filed Feb. 8, 2006, the entire disclosure of which is hereby incorporated by reference herein.

### TECHNICAL FIELD

The present inventions relate to preparation of e-learning content or training software for use in training personnel or students, and, more particularly, to methods and systems for rapid development of such learning content.

### BACKGROUND

Development of electronic learning content and training software has become vital for companies and learning institutions. Internet and intranet systems and related software have become indispensable tools for efficient communication of information and knowledge to employees and students, regardless of their location and schedule. According, such companies and learning institutions are beginning to rely more and more on these tools for quick, efficient, and effective distance learning. Not only are traditional classes and education materials being delivered via this medium, but companies are increasingly utilizing internal, custom-developed courseware programs for training employees about their business and procedures and about their current and potential customers. Knowledge from diverse areas and locations of the company can thereby be shared and communicated to employees en masse, without the expense and time requirements of in person seminars and traditional lectures. For instance, the company may use such an electronic courseware medium, accessible via the company intranet, for training service technicians about procedures to be utilized in repairing certain products in the field, or for training salespersons about the company's prospective customers to better communicate with such customers in order to grow the company business. Once developed, the courseware program can be easily accessed by all desired employees and utilized continually for training of new and existing personnel.

Such learning content can include a variety of electronic materials, including video and audio clips, graphics, text, and animation to communicate and teach the topics at issue. The materials can be consolidated in a series of screens or pages that present concepts to the user via a computer display, typically in a flowing interactive graphical or animated manner using a web browser program or similar user interface. The user may then interact with the content, such as by using a mouse and keyboard to answer questions, repeat content, skip forward or backward, select items of interest, and generally control the presentation of the materials at the desired pace and in the desired order.

However, the development of such programs can be time consuming and tedious. Often, thousands of manhours can be required for the creation and conglomeration of text, graphics, video clips, audio and voiceovers, artwork, and other content into an easy to use, effective software training program. The software developers typically are not experts in the subject matter, and often will be outside vendors. Therefore, the developers need to consult with various experts in the subject matter in order to gather the most appropriate content for the course and organize it in the most effective manner. Preparation and programming of the various animation files, video files, graphic files, and text into highly effective and coherent presentation can be a laborious task.

However, because of the labor requirements involved with conventional development of interactive and effective distance learning programs, the institution that desires the program is frequently faced with a dilemma. It may either spend the time and money for custom development of a quality, effective distance learning program that includes rich media delivery such as via graphics, videos, animation, and voiceovers. Or it may sacrifice quality and effectiveness and settle for a less costly, less interactive, static program that includes only basic media, such as only graphics and text. Heretofore, the dilemma has not been resolved and there remains a need for cost-effective, quality distance learning software that can be provided more quickly. There further remains a need for methods and systems for developing such courseware that is easily utilized by subject matter experts and allows for efficient combinations of complex media content.

Accordingly, methods and systems are desired for efficiently developing sophisticated training courseware or distance programs that are highly effective in teaching concepts to students or employees.

### SUMMARY

According to one embodiment, a method for developing learning content for presentation by a computer of a plurality of displayed pages as part of an executable computer-implemented learning program is provided. The method comprises presenting to a subject matter expert a pre-existing suggested course outline having a plurality of predefined course outline concepts, wherein the subject matter expert is experienced in a topic to be presented in the course, and receiving a selection of at least one predefined course outline concepts from the suggested course outline. The method further comprises presenting to the subject matter expert a plurality of predefined page types, wherein each page type defines the order of presentation of media elements in a single course page, and receiving a selection of at least one predefined page type based upon the selected common course outline concept. The method also comprises presenting to the subject matter expert a predefined storyboard template based upon the selected predefined page type, and receiving from the subject matter expert the predefined storyboard template that includes content filled in by the expert. The content includes text for presentation to the student, text to be used as spoken audio, and text that describes actions that should occur on the screen. In addition, the method comprises creating instructional graphics and instructional voice content based upon the content in the completed storyboard template, and providing the graphics and voice content in a series of moving computer displayable pages, wherein the pages are for use in an executable computer-implemented learning program.

According to another embodiment, a computer implemented method is provided for developing learning content for presentation by a computer of a plurality of displayed pages as part of an executable computer-implemented learning program. The method comprises presenting to a subject matter expert a plurality of predefined page types, wherein each page type defines a general method for presenting information within the course by presenting multiple related media elements to the user. The method further comprises receiving a selection of at least one predefined page type, and presenting to the subject matter expert a storyboard comprising a series of templates, each template requesting information be filled in by the subject matter expert, wherein the storyboard presented is based upon the page type selected. In addition, the method comprises receiving inputs from the subject matter expert to fill in the page templates of the storyboard, and generating a computer-implemented instructional program comprising a moving multimedia presentation based upon the inputs. The storyboard may comprise a series of slides with questions and instructions for the subject matter expert, and each storyboard may have a corresponding multimedia template file that is filled in by the developer based upon the information provided by the subject matter expert. The storyboard may alternatively be presented via an editor with fields representing points in the multimedia presentation permitting which are customized by the subject matter expert, the fields being converted into a multimedia presentation file.

According to another embodiment, a method is provided for developing learning content for presentation by a computer of a plurality of displayed pages as part of an executable computer-implemented learning program. This method comprises presenting to the subject matter expert a predefined template defining a summary of the course topics and order, and receiving from the subject matter expert the predefined template that includes content filled in by the expert. Additionally, the method comprises generating computer displayable pages based upon the content, wherein the pages are for use in an executable computer-implemented learning program.

According to another embodiment, a method is provided for developing learning content for presentation by a computer of executable interactive multimedia computer-implemented learning program. The method comprises presenting to a subject matter expert a predefined storyboard including representations of points in an interactive multimedia presentation, the points defining the flow and content of the multimedia presentation. The method further comprises receiving from the subject matter expert content filled in by the expert for each point of the storyboard, wherein the content is appropriate to the learning purpose. In addition, the method comprises generating an electronic interactive multimedia presentation based upon the content for the various points, wherein the presentation is for use as an electronic training course.

### BRIEF DESCRIPTION OF THE DRAWINGS

While the specification concludes with claims particularly pointing out and distinctly claiming the present invention, it is believed the same will be better understood from the following description of examples taken in conjunction with the accompanying drawings wherein like numerals indicate corresponding elements and wherein:

FIG. 1 is a flow diagram illustrating an example of a process that can be utilized for efficient creation of a content rich, multimedia computer-implemented e-learning program, according to an aspect of the present invention;

FIG. 2 is an example of a electronic course outline template that can be utilized for efficient creation of a computer-implemented e-learning program, according to an aspect of the present invention;

FIG. 3 is an example of a display used for selection of page types for efficient creation of a computer-implemented e-learning program, according to an aspect of the present invention;

FIG. 4 is an example of a display used for selection of assessment page types for efficient creation of a computer-implemented e-learning program, according to an aspect of the present invention;

FIG. 5 is an example of a display used for selection of process page types for efficient creation of a computer-implemented e-learning program, according to an aspect of the present invention;

FIG. 6 is an example of a display used for presenting a sample of the selected assessment page type, for viewing by a subject matter expert during creation of a computer-implemented e-learning program, according to an aspect of the present invention;

FIG. 7 is an example of a display used for presenting a sample of the selected assessment page type, for viewing by a subject matter expert efficient creation of a computer-implemented e-learning program, according to an aspect of the present invention;

FIG. 8 is an example storyboard having multiple template slides defining points of a multimedia presentation for use by the subject matter expert in developing the selected assessment page type, according an aspect of the present invention;

FIG. 9 is an example storyboard having multiple template slides for use by the subject matter expert in developing a different selected assessment page type, according an aspect of the present invention; and

FIG. 10, from FIG. 10a to FIG. 10d, is an example storyboard having multiple template slides for use by the subject matter expert in developing a selected page type, according an aspect of the present invention.

### DETAILED DESCRIPTION OF ILLUSTRATIVE EMBODIMENTS

In general, embodiments relate to methods and systems for rapid and efficient development of content-rich customized e-learning programs. In some embodiments, the subject matter expert is presented with a variety of predetermined page types for potential use in teaching a topic. Based upon the page type selected, a storyboard template is provided defining points of a multimedia presentation, the template having guidance for the subject matter expert to fill in information related to the page type. The information can include text to be displayed, text indicating what is to be spoken in a voiceover, and/or text indicating what action is to take place on the screen. Based upon the content filled into the storyboard by the subject matter expert, multimedia animation templates that mirror the storyboard are then filled in and generated for use in an electronic learning format. The templates can be flash movies and can include graphics, animation, voiceovers, videos, interactive mouseover effects, and other rich content.

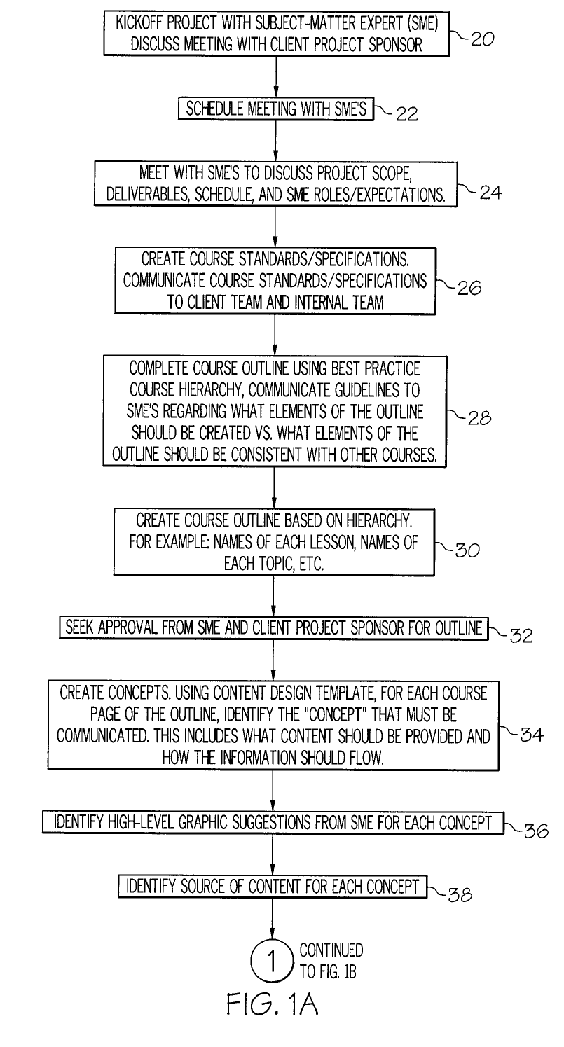

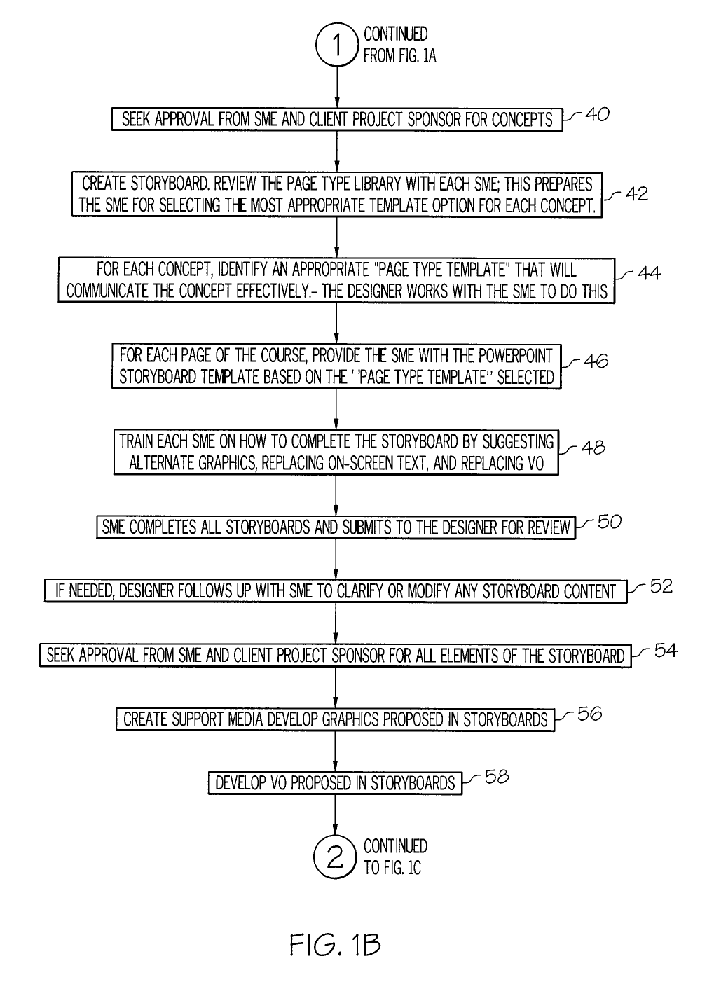

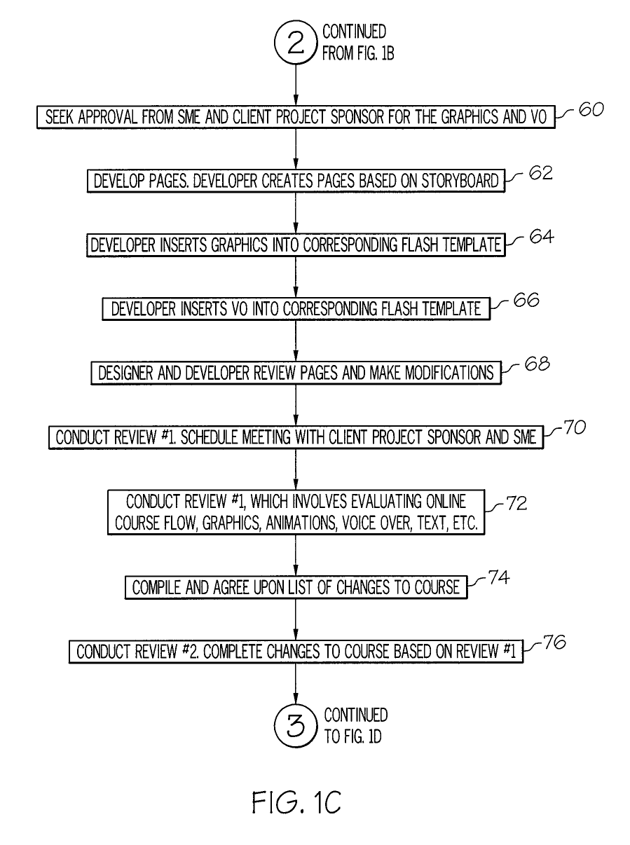

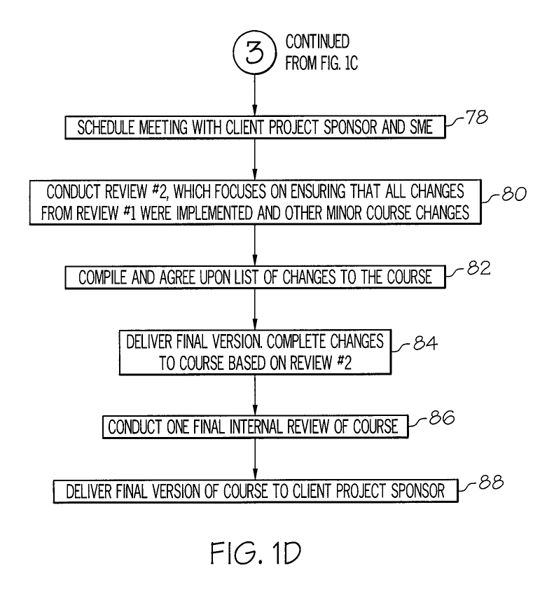

FIG. 1 is a flow diagram illustrating an example of a process that can be utilized for efficient creation of a content rich computer-implemented learning program, according to an aspect of the present invention. As shown in this example, at block 20, the project is initiated by the software designer discussing with the client or project sponsor the type of electronic course that is desired, and who the expert is on the subject that will provide the content for the electronic course. The course can comprise a training course for training employees on a particular business, on the businesses of potential customers, or on business procedures that are to be followed. Other academic, business, technical, or leisure topics can be presented according to the method as well. The subject matter expert can be employed by the sponsor/client, or the software designer can be charged with the task of locating an appropriate expert to provide content for the desired topics.

Once the subject matter expert (SME) is identified, a meeting is scheduled with the expert, as shown at block 22. At the meeting, the project scope, deliverables, schedule, and the roles/expectations of the SME, as shown at block 24. Then, the course standards and specifications can be developed by the SME and designer, as shown at block 26. These standards and specifications can comprise all information that will be standardized for the course including size of windows to be used for the content, color schemes, fonts, user interface layouts, location of navigation and resource buttons, location of menus, and style of imagery to be used. These standards and specifications are communicated to the client team and the internal development team.

A template course outline (i.e., best practice course hierarchy) is then presented to the SME for use in customization by the SME. For example, each major type of course (industry training, product sales training, software training, product maintenance training, higher education, etc) can have a predefined template associated with it that outlines how a well designed course would be organized, in terms of lessons, topics, concepts, tasks, processes, simulations, and assessments. Standard lessons and topics can be provided in the outline along with a mix of concepts, tasks, processes, simulations, audio, video and assessments to create an effective training module. Accordingly, the hierarchy provides a template for rapidly moving from training need to content development. An example of a course outline is shown in FIG. 2. In this example, the outline comprises a spreadsheet 102 including a number of suggested general lessons 104 to be covered in the course. Each general lesson 104 includes a number of topics 104′ which are related to each lesson but which further define each lesson. For example, if the overall course was on computer based training courses, one of the lessons may be an introduction and other lessons may be specific to completing distance education courses. Topics under the completing distance education lesson can be a) introduction to distance education and b) writing research papers in distance education courses, for instance. Each topic 104′ can correspond to a single flash page of the training program to be developed. (Flash page is used generically to include any interactive, animated multimedia electronic presentation, whether or not in a conventional flash format, MACROMEDIA FLASH format, or other format). Accordingly, for each topic 104′ for each lesson 104, the relative length of time of the flash page, the type of flash page, and the description of the content of the flash page can be presented in the columns 106, 108, and 110 of the outline 102. The page type 108 can indicate what, how, and when items are displayed to the user and how the user is to interact with the displayed items. For example, for some topics, the user can be presented an image and appropriate text is displayed as the user mouses over parts of the image, the displayed text corresponding to the part that is moused over. As another example, the user can be presented text and an image fades in. As a further example, the user can be presented a quiz and allowed to enter answers to the questions in the quiz. With respect to the description column 110, these descriptions provide additional detail as to what specifically each subtopic flash page will be conveying to the user. Accordingly, the course outline 102 provides a pre-existing template of a flow of a computer implemented course and suggestions for timing, content, and types of pages that can be displayed to the user. The template outlines provided to the SME can comprise outlines that have been found to be effective in terms of timing and user interaction and which are most related to the information to be taught by the SME. The designer and SME can work together in selecting the most appropriate outline template. Lessons and topics are displayed to the user along with a column for content in which the SME would begin to describe the concept that must be communicated for the respective topic.

Returning again to FIG. 1, these outlines are communicated to the SME's along with guidelines regarding what elements of the outline should be created from scratch and what elements of the outline might overlap with existing template outlines. These steps are shown at blocks 26 and 28 of FIG. 1. The designer, with input from the subject matter expert, can then create the course outline by modifying the outline template and adding additional lessons and topics as needed for the subject at hand, as shown at block 30. The resulting outline that is created is then sent to the SME and the project sponsor for approval, as shown at block 32.

Using the course outline (i.e., content design template), for each page of the course (each topic 104′), the designer identifies the concept that is to be communicated (from the description 110), and how the information is to flow (from the page type 108). This step is shown at block 34 of FIG. 1. For each such concept, the SME is requested to provide suggestions for high level graphics that would be appropriate, as well as a source of content for the concept. High level graphic suggestions are the visual suggestions that an SME might provide to the content developer regarding how to best show concepts that will persist and be used on multiple pages throughout the course. For instance a high level graphic suggestion might be a process flow or a product image that may be reused to assist in conveying multiple related concepts, each related concept corresponding to a part of the process or a part of the product. The source of content can be anything that currently provides the information needed to explain the concept—e.g., a manual, a Word document, a Powerpoint presentation, a Web site, a book, or even an individual. It generally contains the content to be used to present the concept, but is a more comprehensive version of it that needs to be distilled down into something that can be used for effective training. For example, if the SME were presenting a concept related to how to write a research paper, the SME might suggest showing a detailed graphic of a proper research paper outline with the various parts of the paper shown (and to be defined), and, as for content, the SME might suggest a title of an book that the SME wrote regarding writing research papers. Based upon the suggestions, the designer then locates appropriate graphics and begins compiling appropriate content describing the concepts to be presented. The designer may need to prepare, or have a developer prepare, electronic graphic files that show the high level graphic appropriately, and then consult the content source (e.g. a book or article or manual) and review the source to develop a concise summary of the concept to be conveyed. These graphics and extracted content are then sent to the SME and sponsor for approval, as shown at block 40.

The SME can then be requested to select page types for each concept/topic. To prepare the SME for this process, the designer may review an existing electronic library of page types with the SME to prepare the SME for selecting the most appropriate template option for each concept, as shown at block 42. This review can entail showing the SME the various possible sample page types in the library, explaining what they are generally directed toward, and how they are typically used. Each page type can comprise a general methodology or sequence of media elements to be displayed to the user for presenting information to the user. For example, “assessment” page types can be different ways of electronically presenting questions or testing the student, while “process” page types can comprise different ways of describing the parts of a process to the student. Other page types can include introduction types and procedures types.

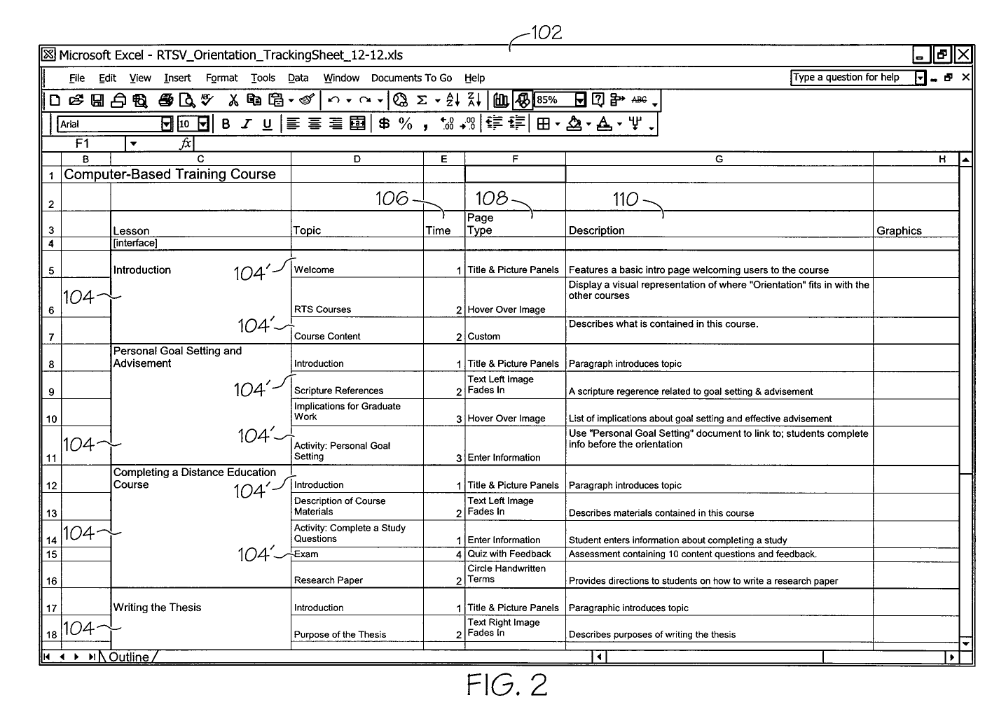

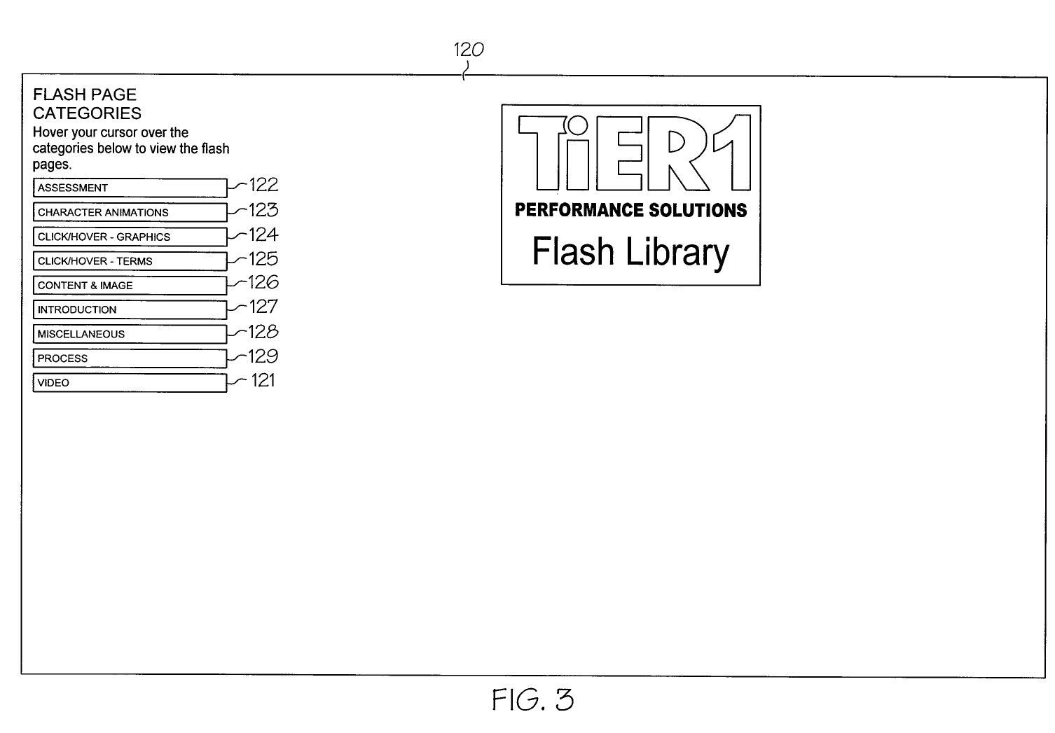

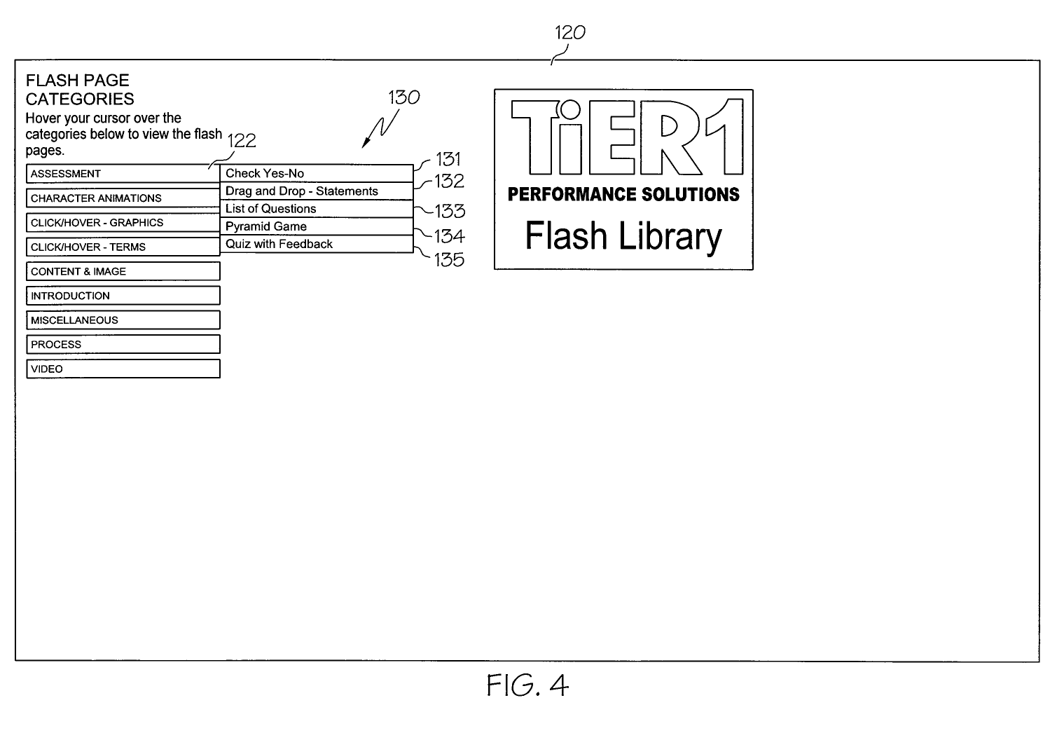

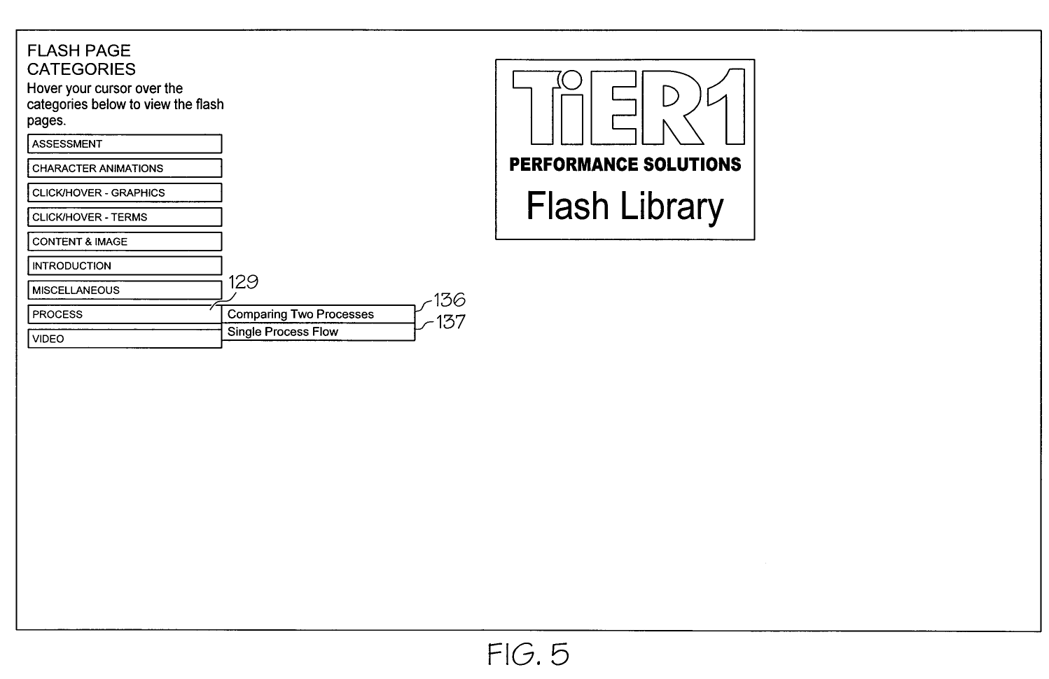

Then, as shown at block 44, for each concept, the SME and designer work together to select an appropriate page type template is identified that will communicate the concept effectively. FIGS. 3-7 illustrate examples of the operation of software that can be provided to facilitate this selection process. In particular, as shown in FIG. 3, the software can present a library screen 120 to the SME showing various example categories of flash page types. These categories can be represented by selection boxes 121-129 to allow the SME to select page types for assessments, page types for character animation, page types for click/hover on graphic, page types for clicking/hovering on terms, page types for display of content with images, page types for presenting an introduction, page types for displaying miscellaneous information, page types for displaying processes, and page types for showing video. Based upon the button selected by the SME using the mouse, the SME will then be displayed a box 130 showing the specific page types available under each category. FIG. 4 shows a box 130 that can be displayed if the user selects the assessment button 122. The example specific page types shown here include selection buttons/links 130-135 for selecting various ways of conducting an assessment or quiz. These can include a page type to have the use check yes or no in response to questions, a page type where statements are to be dragged and dropped to the appropriate location, a page type that presents a list of questions, a page type that presents a pyramid game to the user, and a page type where the user is presented a quiz with feedback being provided based upon the users answers to the quiz. FIG. 5 shows another example of page types that can be selected for the process category using links 136/137. Here the two examples of process page types are a page type that compares two processes and a page type that presents the flow of a single process.

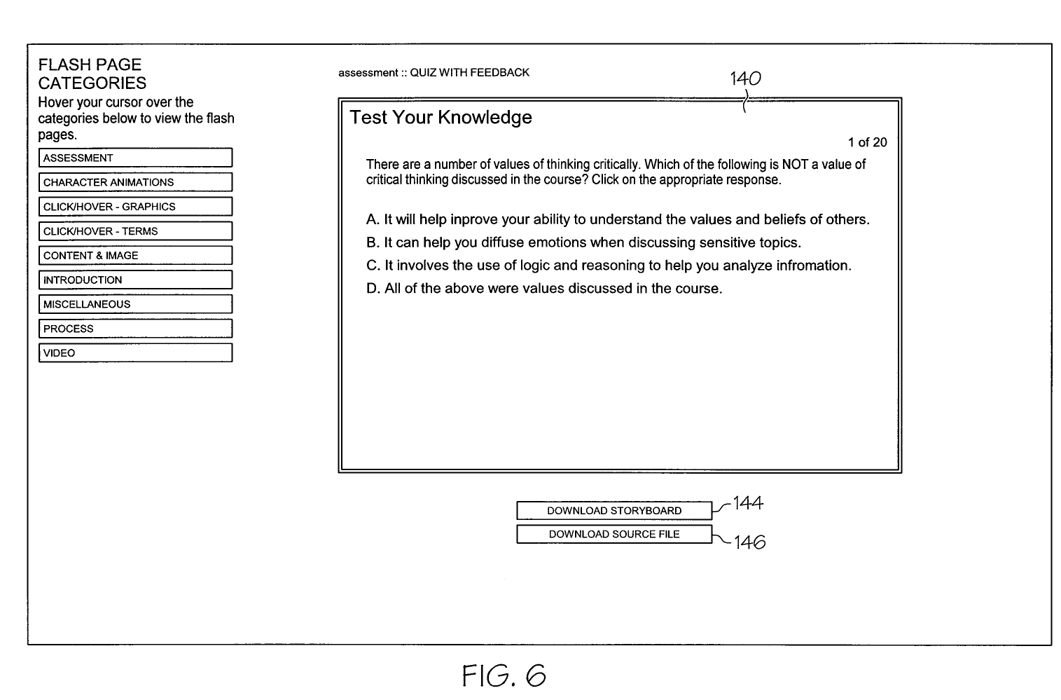

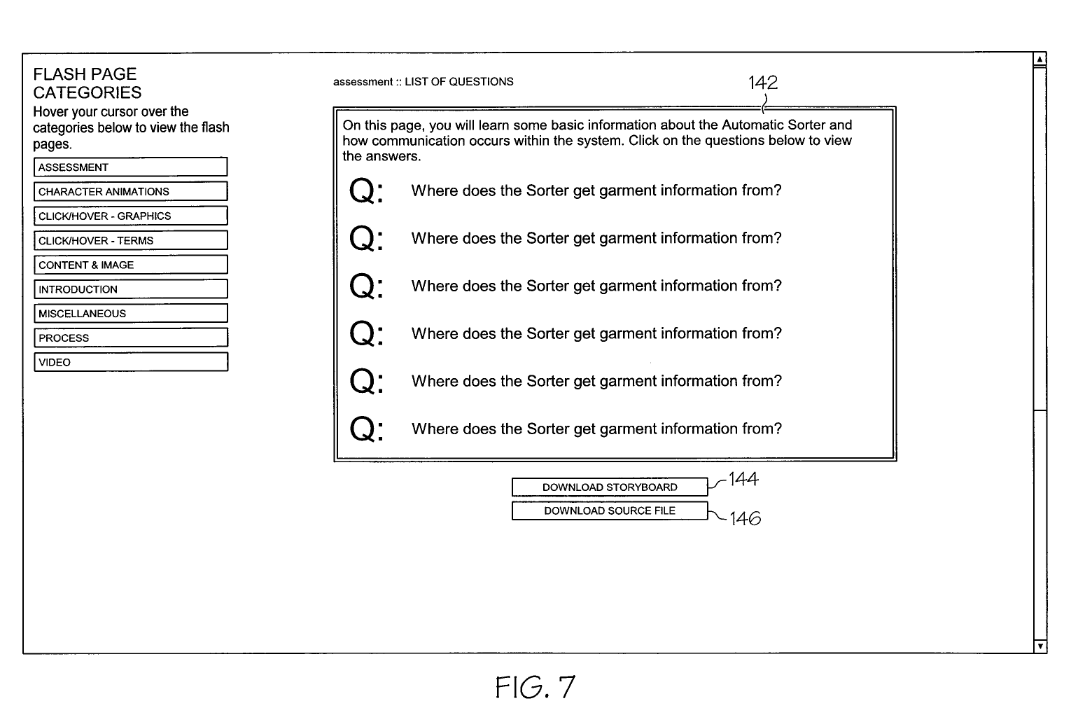

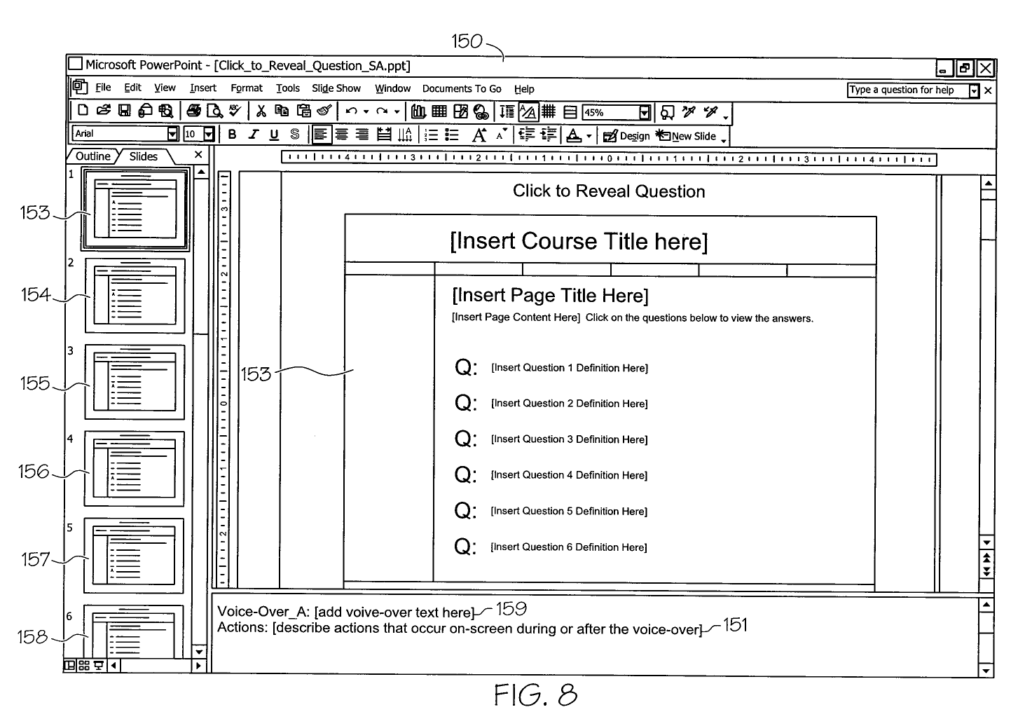

Once one of the buttons 130 is selected, the program displays a corresponding example of the selected page type. For example, FIG. 6 shows a sample flash page 140 showing an example of how the “quiz with feedback” page type would typically be executed if the button 135 were selected in FIG. 4. Here the user is presented a question and requested to select the appropriate response. If the SME is interested in preparing a similar page type for the given concept of the course outline, the SME can then use button 144 to download an editable electronic storyboard (e.g., in editable presentation slide format) to allow the SME to customize the questions/answers for the particular concept. Alternatively, the SME can download the source file (in editable flash format) using button 146, allowing the SME to modify points of a flash file directly in the source code, or indirectly such as via a graphical user interface requesting points be filled in or via an intermediary file having points that are modifiable by the expert. As another example, and as shown in FIG. 7, if the “list of questions” page type were selected using button 133 of FIG. 4, then the program can cause a sample flash file 142 to be presented to the SME on the screen showing how questions can be presented to the student and the student is prompted to select the question to view the corresponding answers to each. Again, the electronic storyboard or the electronic flash file can be edited using buttons 144 and 146. Accordingly, a storyboard can be a document that defines specific points in the flow of an animated, interactive electronic multimedia presentation, such as via slides, fields, data points and the like, and the subject matter expert fills in these points with appropriate content. The storyboard may present the points as a presentation file having slides (e.g., a PowerPoint file), a flash source code file having modifiable portions, a editable computer file, or as a graphical user interface having displays that request the information, for example.

Accordingly, with reference again to FIG. 1, in this example, the SME is provided with an editable storyboard for each page type selected, such as in the form of a flash or presentation file, that can be used to generate the given page for the given concept. This is shown at block 46 of FIG. 1. The presentation file can comprise a Powerpoint presentation file with a number of editable slides that the SME edits in order to customize the storyboard template. An example of such a template is shown in FIG. 8. Here, the “click to reveal” page type has been selected using the mouse, causing a file to be executed and displayed to the SME in window. Here, the file comprises a series of predetermined slides that represented the various states of a flash page and that include guidance and instructions to assist the SME in customizing the slides for the desired concept. The SME can then customize each of the slides to indicate how they would like the flash page to flow and to set the various states of the flash page. For instance, slide 153 can represent the initial state of the flash page, which presents a list of questions related to the concept to the student. Then, in the resulting flash page to be created, as the student clicks on one of the questions, the correct answer is to appear. Accordingly, the SME is directed to fill in answers to each of the questions in the remaining slides 154-158. For instance, in slide 154, the SME is directed to fill in the answer to the first question in the spot where the first question appeared. In slide 155, the SME is directed to fill in the answer to the second question in the spot where the second question appeared. The SME continues this for each of the slides. Accordingly, the storyboard template of this example provides still frames of the flow or transitions of the flash page to be developed, and the template directs the SME to fill in appropriate content for the concept at hand. Addition instructions can also be provided by the SME. For example, a location 159 can be provided in each slide to allow the SME to type in what spoken audio (e.g., voiceover) should be provided to the student at that point in the flash program. In addition, a location 151 can be provided on the slide to allow the SME to indicate what actions (e.g., animations, moving text, etc.) should occur on the screen during or after the voiceover. Accordingly, the SME is provided with an effective means for defining the states of a flash page to be developed to convey a concept, and is provided with guidance on how to define those states.

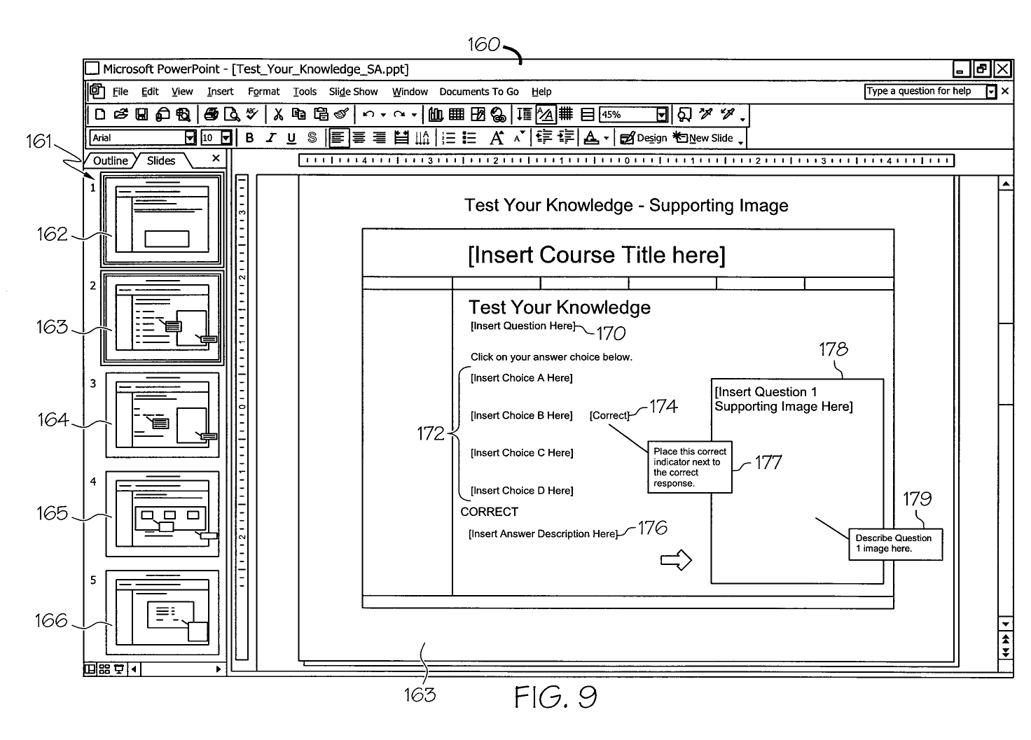

FIG. 9 provides another template of slides for use by the subject matter expert in developing a different selected assessment page type. Here, the SME selected the “quiz with feedback” page type from the button 135 on the window of FIG. 4. In response, the computer displays slides 161 that have locations guiding the SME to provide certain information that can be used to developed a quiz type flash page. For instance, the slide 162 can have editable text 170 instructing the SME to type in the first question over the text instructions at that location, editable text 172 instructing the SME to type in possible answers to the questions over the text instructions at those locations, movable text 174 that can be moved by the SME next to the answer that is correct, and editable text 176 instructing the SME to describe the correct answer (so that the developer will know which answer is correct) by typing over that text. Moreover, additional instructions can be provided such as at locations 177 and 179. In addition, an image location 178 can be provided that instructs the SME to place an image at that location that would correspond to the question being asked (e.g., if the question is related to writing reports, an image of a report can be placed at the location 178, such as by electronically cutting and pasting an electronic image or electronically importing an image file). The SME proceeds to fill out all of the slides 161 to describe the various states of the quiz, to indicate how it will be developed into a flash page and to customize the quiz according to the concept presented.

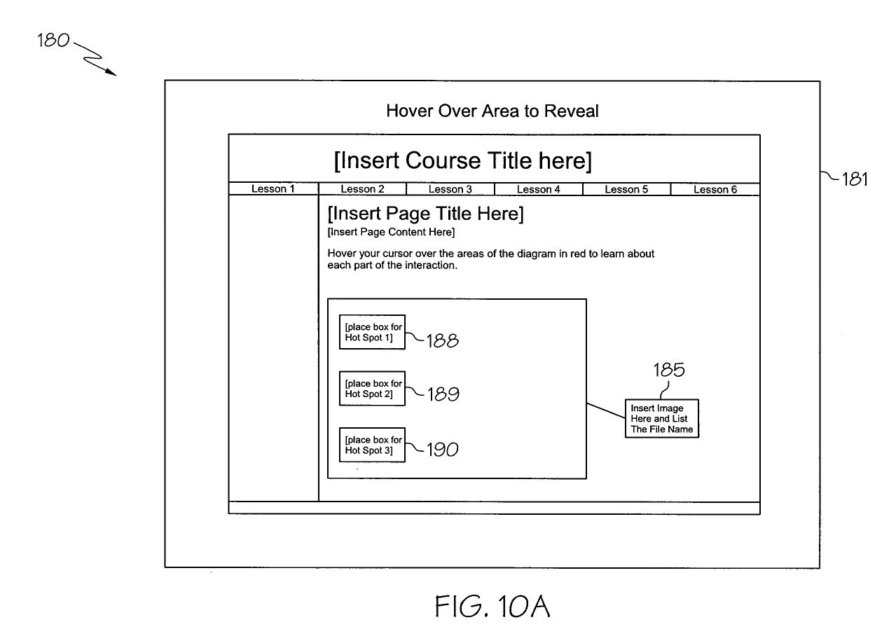

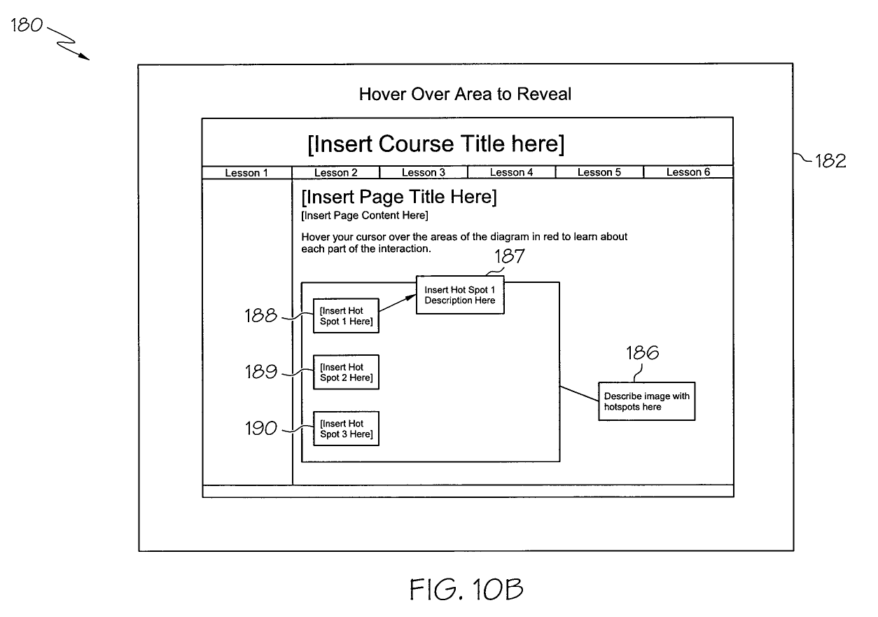

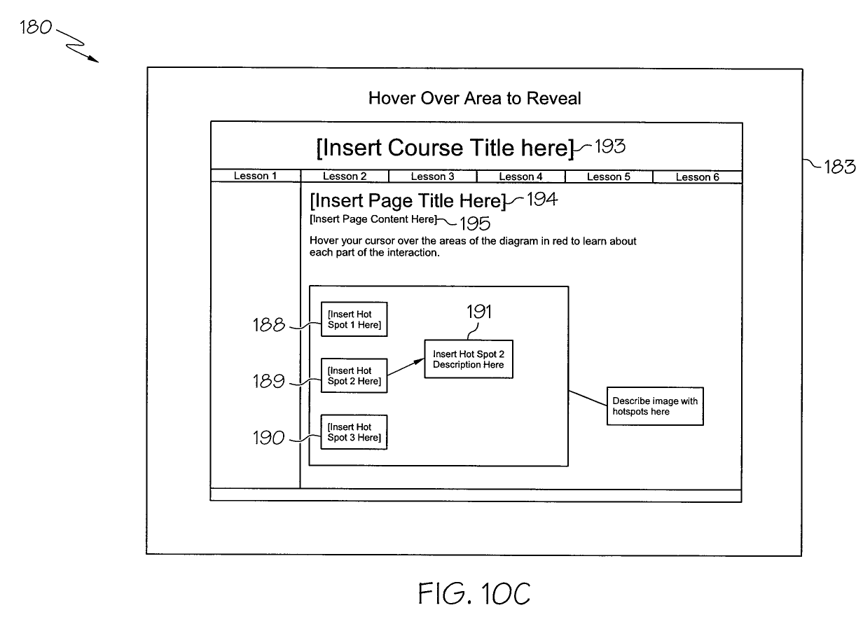

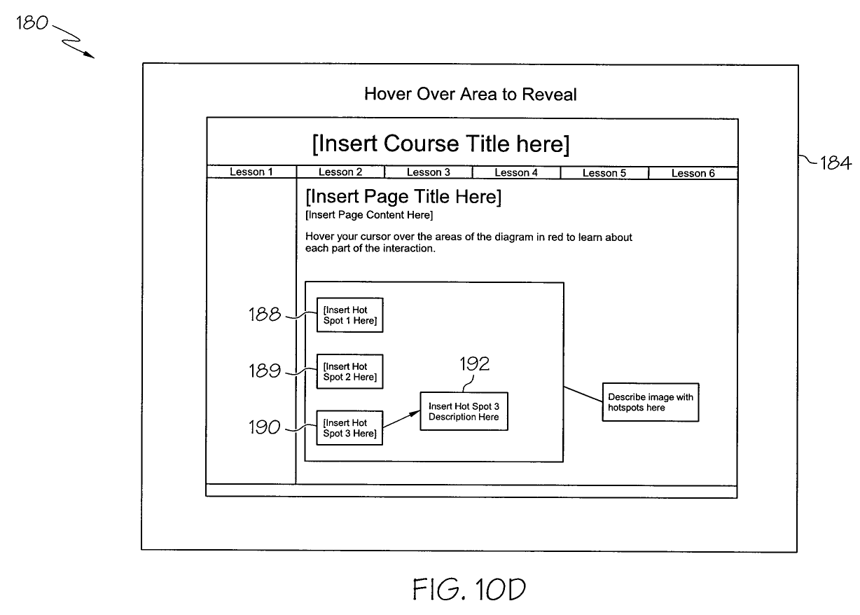

FIG. 10, from FIG. 10a to FIG. 10d, is another example storyboard having multiple template slides 180 for use by the subject matter expert in developing a selected page type, wherein the page type is for illustrating a graphic of the concept being taught, such as a product or process, and for describing the parts of the concept. In this example, slide 181 provides text instructions 185 for the SME to insert the image of the concept. Accordingly, the SME might insert an electronic image of a product if it were a product being described. On the following slide, 182, the SME is then instructed using editable text 186 to describe what the image is by typing over the editable text 186. The SME is also instructed by text 187 to describe the first “hotspot”. The hotspots will be the parts of the image that will be described in the flash page to be developed, and for which a description will appear on the screen when the student hovers or mouses over those parts of the image. The SME can use editable text boxes 188, 189, and 190 to define what each of the parts of the image are. For example, the SME might describe the first hotspot in box 188 as the top of the product, the second hotspot in box 189 as the middle of the product, and the third hotspot in box 190 as the bottom of the product. Then, using box 187, the SME can provide the definition of the first hotspot. For example, the SME might type what the top of the product is and what its function is. This indicates to the developer that, in the final flash page to be developed, this typed text should then appear on the screen when the student hovers over the top of the image. Similarly, in slides 183 and 184, the SME can describe to the developer what the second and third hotspots are and their functions using editable text boxes 191 and 192. Additional editable text locations 193, 194, and 195 can be provided for the SME to provide additional text to appear on the page, such as the course title (e.g., “overview of the electronics industry”), the flash page title (e.g. “digital cameras”), and the particular content being described by the image (e.g., “parts of a digital camera”). Accordingly, by being provided with sample flash pages and with storyboard templates, the SME is provided with assistance and guidance in selecting effective flash pages for teaching a concept, in customizing the content for the pages, and in instructing the developer how the course should be designed. The assistance and guidance is provided in an easy to use and communicated, and time efficient manner.

Returning again to FIG. 1, the SME is trained on how to complete the storyboard, as shown at block 48. This can be conducted by the designer explaining how to suggest graphics, replace text on the storyboard, and insert text for indicating voiceovers. The SME then completes the storyboards and submits them to the designer for review, as shown at block 50, such as by emailing the modified files to the designer. If needed, the designer then follows up with the SME to clarify or modify any questions regarding what the SME has provided on the storyboards.

From the storyboards, the designer is then prepared to develop appropriate media elements for use in the final flash pages, and then to actually create the flash pages. For example, as shown at block 56, the designer can create graphics based upon what is proposed in the storyboards. In other words, based upon the SME's description of graphical elements to be used and/or based upon graphic files provided by the SME, the designer can create graphics relating to the desired content. A graphics library can be consulted to assist with this, and graphic or image editing software can be used to make modifications as needed. The voiceovers proposed by the text of the storyboards can also be developed by the designer, as shown at block 58. Actors, voiceover artists, or narrators can be contracted to record the spoken audio desired to create the sound files that will be utilized in the flash pages. The graphics and voiceover files can then be sent to the SME and project sponsor, such as via email or Internet download, for review and approval, as shown at block 60. Video, animation, simulations and other elements desired by the SME can also be constructed in a similar manner by use of software and by recording equipment. These elements are also submitted to the SME and sponsor for approval

Once these media elements are ready and approved, the designer may develop the flash pages using these elements and based upon the storyboards as shown at blocks 62-66 in the example of FIG. 1. In particular, the graphics and voiceovers and other elements are inserted in to the flash files, as shown at blocks 64 and 66. Flash development software, such as MACROMEDIA FLASH for example, can be utilized by a flash developer to create the actual flash pages based upon the storyboard. Each storyboard of slides will result in a single electronic flash page/movie/program, with interactive elements, audio, video, text, animation, and/or graphics, and each flash page will correlate with one of the page types suggested to the SME. Each storyboard thus instructs the developer as to how to construct the flash page. Each flash page will also correspond to one concept or topic on the course outline, and the developer programs the timing and flow of each page based upon the outline and storyboards. The developer in particular also programs the browser type interactive user interface controls that are controlled by the student via a mouse or other input device, using flash programming tools. The flash file is programmed to react to the user inputs as desired to create the appropriate display of text or animation, playing of audio or video, or movement between pages, in response to the user inputs. In at least some embodiments, the developer has a number of content-rich flash templates ready for use in creating the flash page based upon the storyboard selected. Each flash template corresponds to or mirrors one of the storyboards (and each storyboard corresponds to one of the page types). Accordingly, in the example of FIG. 6 (the “test your knowledge” page type), there would be a specific predefined storyboard for this page type as well as a specific predefined flash template for this page type. In this embodiment, the SME fills in the storyboard and the developer then takes that information and fills in the flash template, cutting and pasting graphics and text where possible and appropriate. The flash template, as customized by the developer, is re-saved as a new file and thereby becomes the developed flash page.

The course designer and the flash developer then review the developed pages and revise as necessary, as shown at block 68. Then, a meeting is scheduled with the sponsor and the SME to review what has been developed, as shown at block 70. The flow and operation of the entire course, as well as the flow and operation of individual flash pages, and their graphics, animations, voiceover, text, videos, etc. are reviewed, as shown at block 72. Based upon the review, a list of changes is created, as shown at block 74, and the changes to the course are completed by the flash developer who edits the flash files and their media elements as needed to implement the changes, as shown at block 76. A meeting is then scheduled with the project sponsor and the SME, and the pages and elements reviewed to ensure that all changes were made and that no further changes are needed, as shown at blocks 78 and 80. Another list of needed changes is compiled, as shown at block 82 of the example flow chart, and these changes are also made by the developer by editing the flash files and media elements as shown at block 84. One final review of the courseware program is conducted by the developer and/or designer, and the final version of the program is delivered to the sponsor, as shown at blocks 86 and 88. The sponsor then hosts the course as one or more files on a computer, and the computer can be accessed by students or employees to be trained the sponsor, such as via a network or via the Internet.

Accordingly, the examples of embodiments described above can assist in providing clear guidance to an SME in specifying desired elements for an in depth, content rich and highly interactive distance learning course or e-learning programs. The elements can then be easily converted by a developer into the final electronic course using the page type selections and storyboards created by the SME. Again, the developer can utilize a predefined flash template that corresponds to the storyboard, and fill in information and data into the flash template based upon the information from the storyboard. The embodiments allow for much more rapid and efficient development of the electronic course, while at the same time providing the course with rich content and high interactivity.

As can be understood, the functionality of the routine and the other functionalities described herein can be implemented using software, firmware, and/or associated hardware for carrying out the desired tasks. For instance, the various functionalities described can be programmed as a series of instructions, code, files, or commands using general purpose or special purpose programming languages or programs, and can be executed on one or more general purpose or special purpose computers, processors, other control circuitry, or networks.

The foregoing description of various embodiments and principles of the inventions has been presented for the purposes of illustration and description. It is not intended to be exhausted or to limit the inventions to the precise form disclosed. Many alternatives, modifications and variations will be apparent to those skilled in the art. For example, instead of flash pages, other interactive and animated electronic pages or displays could be provided, and so the term is used to encompass other such possibilities as well. In addition, although the electronic storyboards are presented in slide format in the present embodiments, they may be presented as other editable files as well. Moreover, although multiple inventive aspects and principles have been presented, these need not be utilized in combination, and various combinations of inventive aspects and principles are possible in light of the various embodiments provided above. Accordingly, the above description is intended to embrace all possible alternatives, modifications, aspects, combinations, principles, and variations that have been discussed or suggested herein, as well as all others that fall within the principles, spirit and broad scope of the inventions as defined by the claims.

What is claimed is:

1. A method for developing learning content for presentation by a computer of a plurality of displayed pages as part of an executable computer-implemented learning program, the method comprising:
presenting to a subject matter expert a pre-existing suggested course outline having a plurality of predefined course outline concepts, wherein the subject matter expert is experienced in a topic to be presented in the course;
receiving a selection of at least one predefined course outline concepts from the suggested course outline;
presenting to the subject matter expert a plurality of predefined page types, wherein each page type defines the order of presentation of media elements in a single course page;
receiving a selection of at least one predefined page type based upon the selected common course outline concept;
presenting to the subject matter expert a predefined storyboard template based upon the selected predefined page type;
receiving from the subject matter expert the predefined storyboard template that includes content filled in by the expert, wherein the content includes text for presentation to the student, text to be used as spoken audio, and text that describes actions that should occur on the screen;
creating instructional graphics and instructional voice content based upon the content in the completed storyboard template; and
providing the graphics and voice content in computer displayable pages, wherein the pages are for use in an executable computer-implemented learning program.

2. The method as recited in claim 1, further comprising:
presenting to the subject matter expert a plurality of common interface elements, wherein each common interface element defines control or identification elements to be displayed on a majority of the pages;
receiving from the subject matter expert a selection of at least one common interface elements; and
providing the common interface elements in the pages.

3. A method for developing learning content for presentation by a computer of a plurality of displayed pages as part of an executable computer-implemented learning program, the method comprising:
presenting to a subject matter expert a plurality of predefined course graphics, wherein each graphic is a graphical representation of a concept to be conveyed in a computer-implemented training program, wherein the subject matter expert is experienced in a topic to be presented in the program;
receiving a selection of at least one of the graphics;
receiving text relating to the topic and the graphic; and
combining the selected graphic with the text relating to the topic to create a page, wherein the pages is for use in an executable computer-implemented instructional program.

4. The method as recited in claim 3, further comprising:
modifying the graphic to better relate to the topic.

5. A computer implemented method for developing learning content for presentation by a computer of a plurality of displayed pages as part of an executable computer-implemented learning program, the method comprising:
presenting to a subject matter expert a plurality of predefined page types, wherein each page type defines a general method for presenting information within the course by presenting multiple related media elements to the user;
receiving a selection of at least one predefined page type;
presenting to the subject matter expert a storyboard comprising a series of templates, each template requesting information be filled in by the subject matter expert, wherein the storyboard presented is based upon the page type selected;
receiving inputs from the subject matter expert for filling in the page templates of the storyboard; and
generating a computer-implemented instructional program based upon the inputs.

6. The method as recited in claim 5, wherein the method further comprises:
selecting a predefined flash page template having a basic presentation order and appearance that generally corresponds to the basic presentation order and appearance of the storyboard presented to the subject matter expert; and
inserting information into the predefined flash page template based upon the inputs from the subject matter expert.

7. The method as recited in claim 5, wherein the templates are presented as part of a presentation software program.

8. The method as recited in claim 7, wherein the presentation software program comprises POWERPOINT.

9. The method as recited in claim 5, wherein the instructional program includes flash files.

10. The method as recited in claim 5, wherein the page types are presented by displaying flash files to the subject matter expert.

11. The method as recited in claim 5, wherein the page types include assessment page types comprising displays for presenting questions to the student, and a process page type comprising displays for presenting a process to the student.

12. The method as recited in claim 11, wherein the storyboard corresponding to an assessment page type includes a series of templates with locations for questions and answers to be filled in by the subject matter expert.

13. The method as recited in claim 12, wherein the templates comprise editable slides of a presentation software program.

14. The method as recited in claim 5, wherein the media elements include at least one of text, graphics, sound, and animation.

15. A method for developing learning content for presentation by a computer of executable interactive multimedia computer-implemented learning program, the method comprising:
presenting to the subject matter expert a predefined storyboard including representations of points in a interactive multimedia presentation, the points defining the flow and content of the multimedia presentation;
receiving from the subject matter expert content filled in by the expert for the points of the storyboard, wherein the content is appropriate to the learning purpose; and
generating an electronic interactive multimedia presentation based upon the content for the various points, wherein the presentation is for use as an executable computer-implemented learning program.

16. The method as recited in claim 15, wherein the predefined storyboard comprises at least one of an electronic presentation file having slides representing frames of the multimedia presentation, a modifiable flash source code file, an electronic data file, a graphical user interface having modifiable fields.

17. The method as recited in claim 15, wherein the multimedia presentation is generated by populating a predefined flash template based upon the content for the various points, wherein the predefined flash template corresponds generally in flow to the storyboard presented to the subject matter expert.
